(19) United States
(12) Patent Application Publication
(10) Pub. No.: US 2023/0419232 A1
(43) Pub. Date: Dec. 28, 2023

(54) SYSTEMS AND METHODS FOR MONITORING AND COMPARING PERFORMANCE METRICS ACROSS A GROUP OF TARGETS

(71) Applicant: Talent Highway Corporation dba Seed Talent, Chicago, IL (US)

(72) Inventors: Kurt Kaufmann, Chicago, IL (US); David Friedman, Highland Park, IL (US); Rona Borre, Highland Park, IL (US); Jeremy O'Keefe, Henderson, NV (US); Greg Healy, Wilmette, IL (US)

(21) Appl. No.: 18/215,577

(22) Filed: Jun. 28, 2023

Related U.S. Application Data
(60) Provisional application No. 63/356,284, filed on Jun. 28, 2022.

(51) Int. Cl. G06Q 10/0639

(52) U.S. Cl. CPC G06Q 10/06393

(57) ABSTRACT

A system may include one or more enterprise computing (EC) systems and a computing platform, which may include a sales data module, a content selection module, an account module, or a data storage. Each EC system may track target sales data for targets and send the target sales data to the computing platform. The sales data module may receive the target sales data, store the target sales data as sales data, dynamically calculate a threshold based on the sales data, and determine, from the target sales data associated with an target, whether the target sales data for the target is below the threshold. The content selection module may, in response to the target sales data for the target being below the threshold, select training content for the target, and send a notification to the target. The notification may include a link to access the training content.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to U.S. Provisional Patent Application No. 63/356,284, entitled “SYSTEMS AND METHODS FOR MONITORING AND COMPARING PERFORMANCE METRICS ACROSS A GROUP OF TARGETS,” filed on Jun. 28, 2022, and which is pending, the entirety of which is incorporated by reference.

### STATEMENT REGARDING FEDERALLY SPONSORED RESEARCH OR DEVELOPMENT

Not Applicable

### BACKGROUND OF THE DISCLOSURE

The present disclosure generally relates to computing systems, and more particularly to systems and methods for dynamically providing content to a group of targets based on real-time performance metrics and incentivizing certain sets of behavior designed reinforce workplace performance.

Various systems are known in the art for facilitating a task by a user. Such systems can include enterprise computing (EC) systems (EC). One such EC system is a point-of-sale (POS) system for processing a sale or purchase transaction. Other such systems can include manufacturing systems, customer service systems, inventory management systems, compliance systems, business control systems, labor management systems, marketing systems, promotions systems, or other similar systems. While these EC systems and other systems are adept at assisting employees or other users in performing a desired task, they are not configured to aid such users in improving their sales or other performance metrics associated with user success.

While systems for tracking employee performance data exist, one technical problem inherent in these systems use static metrics to determine whether an employee or user is succeeding. If an employee is underperforming, the employee's employer may select remedial content based on what the employer feels would most help the employee improve.

Furthermore, conventional EC systems are not able to detect certain improvements in employee performance metrics. Such systems are limited in that they have no way of determining, from the data they analyze and generate, whether the data demonstrates improvement in the tracked employee. The system's operator may select remedial implement content based on what the employer feels would most help the employee in order to improve the target's performance, but the system has no way of determining whether new data shows improvement in the employee.

What is needed, then, are systems and methods for dynamically providing content.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a system including one or more enterprise computing systems. The system may include a computing platform. The platform may include a performance data module, a content selection module, an account module, an incentive module, and/or a data storage. Each enterprise computing system may be configured to track target performance data for one or more targets (employees, stores, regions, etc.) and send the target performance data to the computing platform. The performance data module may be configured to receive the target performance data from the one or more performance systems, dynamically, in real time, or periodically calculate a target performance threshold based on aggregated target performance data from all targets, and determine, from the target performance data associated with a selected target, whether the target performance data for the target is below the threshold. The content selection module may be configured to, in response to the target performance data for the target being below the threshold, select training content or other remediation action for the target, and send a notification to the target. The notification may include a link to access the training content or links to other remediation action dynamically selected to correct or reinforce a behavior. The target may view the notification on the target's EC system or may access the training content via a separate computing device such as email or SMS message. The system may provide an incentive (positive or punitive) for engaging in the remediation action. Once completed, the system may then track the positive or negative effects on the tracked data point as a result of the intervention over a period of time.

Another aspect of the present disclosure is a system including one or more enterprise computing (EC) systems. The system may include a computing platform. The platform may include a sales data module, a content selection module, an account module, and/or a data storage. Each EC system may be configured to track target sales data for one or more targets (employees, stores, regions, etc.) and send the target sales data to the computing platform. The sales data module may be configured to receive the target sales data from the one or more EC systems, dynamically or periodically calculate a target performance threshold based on aggregated target sales data from all targets, and determine, from the target sales data associated with a selected target, whether the target sales data for the target is below the threshold. The content selection module may be configured to, in response to the target sales data for the target being below the threshold, select training content for the target, and send a notification to the target. The notification may include a link to access the training content. The target may view the notification on the target's EC or may access the training content via a separate computing device. In other embodiments, the performance systems can be any suitable performance system, including but not limited to manufacturing systems, machining equipment, industrial trading platforms measuring different types of trade activity, internet websites monitoring user traffic, customer service tracking systems, etc. The system may provide an incentive (positive or punitive) for engaging in the remediation action. Once completed, the system may then track the positive or negative effects on the tracked data point as a result of the intervention over a period of time.

Another aspect of the disclosure includes the disclosed system being able to detect improved data. The target sales data may pertain to a first time period. The communication module may be further configured to receive a second notification indicating that the selected target has completed the remediation content. The communication module may receive second target sales data from the plurality of EC systems. The second target sales data may pertain to a second time period, and the second time period may occur after the content selection module receives the second notification. The computing platform may further include an improvement detection module configured to compare the second target sales data associated with the selected target with the first target sales data associated with the selected target. The improvement detection module may determine an amount of improvement between the second target sales data associated with the selected target and the first target sales data associated with the selected target.

Numerous other objects, advantages and features of the present disclosure will be readily apparent to those of skill in the art upon a review of the following drawings and description of various embodiments.

### BRIEF DESCRIPTION OF THE DRAWINGS

FIG. 1 is a block diagram illustrating one embodiment of a system for dynamically providing content.

FIG. 2 is a block diagram illustrating one embodiment of a computing platform of a system for dynamically providing content.

FIG. 3 is a flowchart illustrating one embodiment of a method for dynamically providing content.

FIGS. 4a-5 show screenshots of embodiments of a user interface on an employee device showing remediation content and progress.

FIG. 6 is a screen shot of an embodiment of an employer interface of the system showing the remediation status of multiple employees.

FIG. 7 is a flow diagram of one embodiment of a method of providing remediation content.

FIG. 8A is a flow diagram of one embodiment of a method of providing remediation content and detecting improved data.

FIG. 8B is a continuation of the flow diagram of FIG. 8A.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)”does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The software platform may include one or more data storages. The software platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described, such software application able to both send and receive pertinent performance data.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

As used herein, the term “data object” may include a logical container for data. A data object may include an instance of an object in a software application implemented with an object-oriented programming language. A data object may include data formatted in an electronic data interchange (EDI) format, such as an Extensible Markup Language (XML) object, a JavaScript Object Notation (JSON) object, or some other EDI-formatted object. A data object may include one or more functions that may manipulate the data of the data object. For example, a data object may include the functions or methods of an object in a software application implemented with an object-oriented programming language.

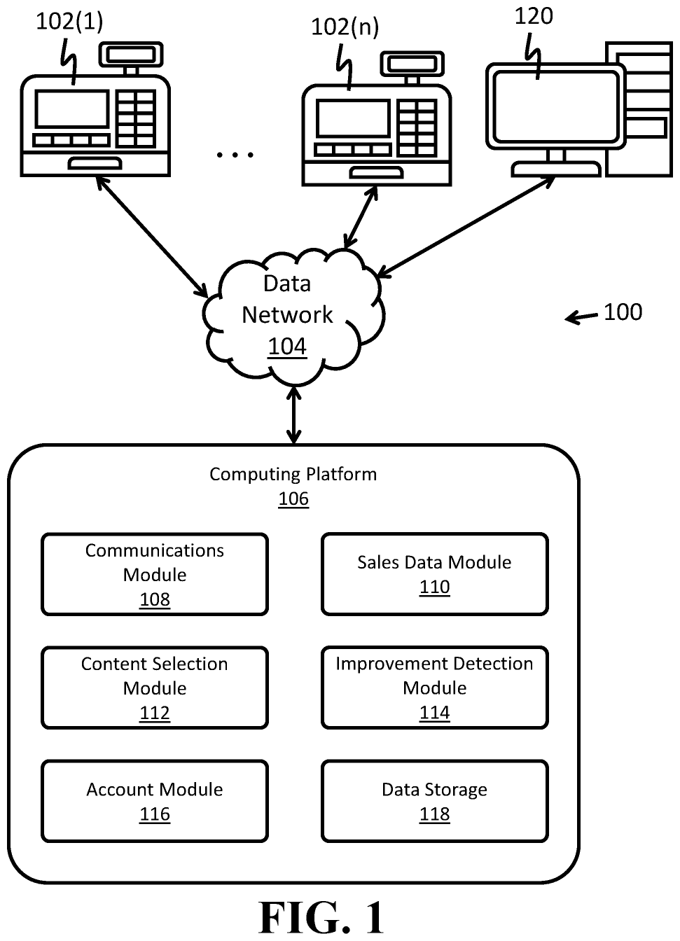

As a general overview, FIG. 1 depicts one embodiment of a system 100. The system 100 may include a system for dynamically providing content. The system 100 may include one or more enterprise computing (EC) systems 102(1)-(n). In some embodiments the plurality of EC Systems can include point-of-sale (POS) systems. The system 100 may include a data network 104. The system 100 may include a computing platform 106. The platform 106 may include a communications module 108, a sales data module 110, a content selection module 112, an improvement detection module 114, an account module 116, and/or a data storage 118. The system 100 may include a computing device 120. The one or more POS systems 102(1)-(n) or the computing device 120 may be in data communication with the platform 106 via the data network 104.

In some embodiments, the plurality of EC systems 102 can include any suitable performance system, including but not limited to manufacturing systems (machining equipment, industrial equipment, etc.), quality inspection systems, compliance systems, production systems, inventory management systems, or other systems with key performance indicators (KPIs) for key roles. Other examples can include stock trading platforms measuring different types of trade activity, internet websites monitoring user traffic, etc. In some embodiments, the performance systems 102 can include point of sale (POS) systems 102 that may be configured to track target sales data for one or more targets and send the target sales data to the computing platform 106. While POS systems shall be discussed hereinafter, the principles and methods discussed herein can be readily applied to other types of performance systems.

In some embodiments, the “target” can be individual employees, subgroups of employees within a retail location, a store or retail location, a sales region, a state, etc. For the sake of convenience, “targets” may be interchangeably referred to herein as “employees” (and similarly “target sales data” may be referred to as “employee sales data” or “sales data”) as it is common to track individual employee performance and address any deficiencies accordingly. However, this disclosure is not limited to tracking solely individual employee performance.

In one embodiment, the communications module 108 may be configured to receive target sales data from each target from the one or more POS systems 102(1)-(n) and store the target sales data as aggregated in the data storage 118. The sales data module 110 may be configured to dynamically or periodically calculate a threshold based on the target sales data, and determine, from the target sales data associated with a selected target, whether the target sales data for the selected target is below the target performance threshold. The content selection module 112 may be configured to, in response to the target sales data for the selected target being below the threshold, select remediation content, or other identified methods of remediation for the selected target, and send a notification to the selected target. The notification may include a link to access the remediation content. The selected target may view the notification on the selected target's individual computing device 120, the POS system 102 at which the selected target is working, or via a separate or central computing device 120.

One advantage of the system 100 over the prior art is that the system 100 can track sales performance for one or more targets and dynamically or periodically calculate a rolling or updated target performance threshold based on continuously updated target sales data to determine when a particular target should receive remediation content. Such dynamic or periodic calculations may include a rolling average or other changing metrics across the plurality of targets. Prior art systems, on the other hand, would compare employee or target performance to a predetermined or static threshold in an inflexible manner.

Another advantage of the present system 100 over the prior art is that the system 100 may also provide remediation content, as well as other drivers to see performance change, including but not limited to statistical sales data information, training or learning modules, product recommendations/bundles, incentives, promotions/discounts, team make-up/scheduling support, best-in-class practices (for employee and consumer—how to insight, DIY tasks, etc. to help improve target performance.

Details of the system 100 will now be discussed. In one embodiment, a POS system 102 of the one or more POS systems 102(1)-(n) may include a cash register, a barcode scanner, a computing device, or other systems operable to facilitate sales transactions. A POS system 102 may include or be in data communication with an inventory management system, a customer relationship management (CRM) system, a financial system, a warehousing system, or other systems. In some embodiments, a POS system 102 may not include a physical POS system but may include a computing device or other type of device where an employee can enter data in order to make a sale. Each POS system 102 may track employee sales data for one or more employees, and the aggregated sales data from all POS systems 102 in the system 100 can capture sales data of the plurality of targets over time.

In some embodiments, an inventory management system can monitor the age and or status of inventory within a store. The system can be programmed to push out alerts to representatives for stale or aging inventory and optionally provide sales training for such products to drive sales and/or provide employee or customer incentives for such aging products to drive sales as well.

In some embodiments, sales data may include data for a particular sales transaction, such as for instance data indicating an item an employee has sold, the quantity of that item sold by the employee, the price at which the employee sold the item, the time or date of the sale, the place of sale, the amount of time the employee spent making the sale, or other sales data. Employee sales data may include whether an item that the employee sold was returned, repaired, refunded, or may include a post-sale customer service data point, or may include some other post-sale activity. It should be noted that, as used herein, an “employee” may include an employee, an independent contractor, or some other type of worker.

The communications module 108 of the computing platform 106 can receive this sales data and store it in the data storage 118. In some embodiments, depending on the desired performance metric to be reviewed, the sales data module 110 may manipulate or aggregate the sales data in various ways. For instance if a company wants to review total employees sales across all items for a given period, the sales data across all items can be calculated for the desired time period for each employee, and that total sales data for the time period can be used to determine the employee performance threshold. If the company is worried about sales of a particular item, such as high dollar/high profit items, the computing platform can calculate total sales data for each employee for a specific item for a specific time period, and such item specific sales data can be used to calculate the employee performance threshold. Thus the performance threshold calculation could then correspond to the desired performance metric to be considered or reviewed.

In still other embodiments, the computing platform 106 could calculate dynamically or periodically a plurality of performance thresholds for various aspects or metrics (total sales, item specific sales, time to complete sales, customer service-related data, etc.) of the aggregate employee data and compare each employee's individual employee sales data along each metric to the corresponding threshold. Multiple remediation programs could then potentially be provided to employees, each remediation program associated with a particular performance metric. If a selected employee's performance data does not meet one or more of the plurality of performance thresholds established by the computing platform, the content module could identify each performance deficiency and send corresponding remediation content or other corrective action to the employee accordingly.

In some embodiments, the one or more POS systems 102(1)-(n) may send the employee sales data to the computing platform 106. The POS systems 102(1)-(n) may send the employee sales data periodically (e.g., every hour, every day, every week, etc.). In some embodiments, the POS systems 102(1)-(n) may only send real time employee sales data that has not been previously sent to the computing platform 106, and the computing platform 106 can process or track the aggregated data at the computer platform 106 level, or the POS system 102 can be programmed to send at least some previously sent employee sales data (such as aggregated sales data for the last day/week/month/year on a daily/weekly/monthly basis with some crossover between transmitted data sets). The sales data module 106 may receive the employee sales data and may store it as sales data.

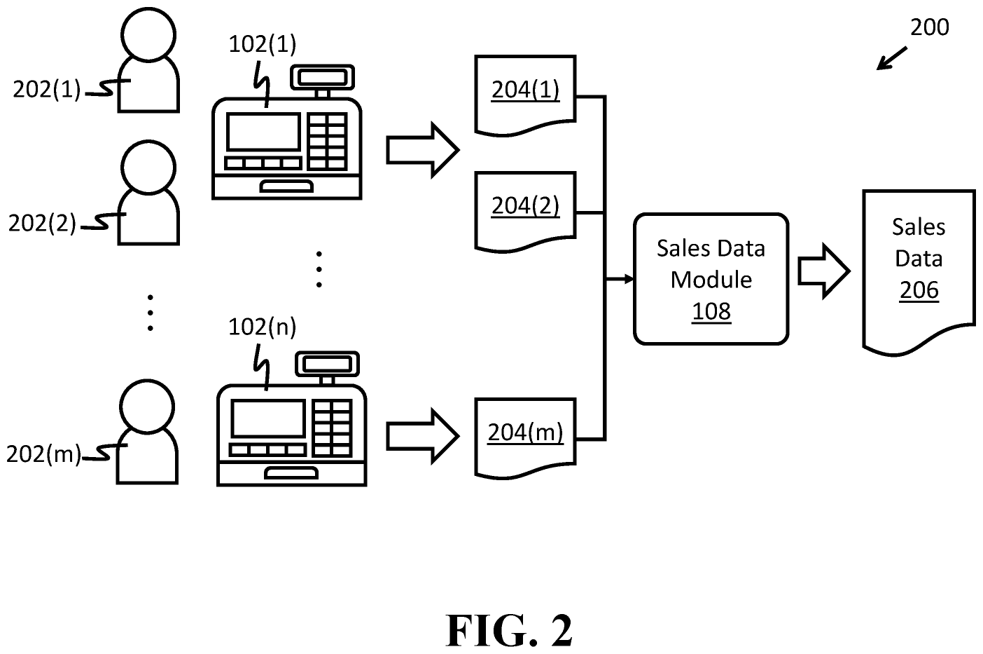

FIG. 2 depicts one embodiment of a data flow 200 of the system 100. The data flow 200 may include one or more employees 202(1)-(m). Each employee 202 may use a POS system 102 to make sales. In some embodiments, multiple employees 202(1)-(2) may use a single POS system 102(1) to make sales. As discussed above, an employee 202 may use a POS system 102 to makes sales, and in response, the POS system 102 may generate employee sales data 204 for that employee 202. Each employee 202 may have his or her own employee sales data 204. Also as discussed above, the POS systems 102(1)-(n) may send the employee sales data 204(1)-(m) to the sales data module 108, and the sales data module 108 may receive the employee sales data 204(1)-(m) and store it as sales data 206.

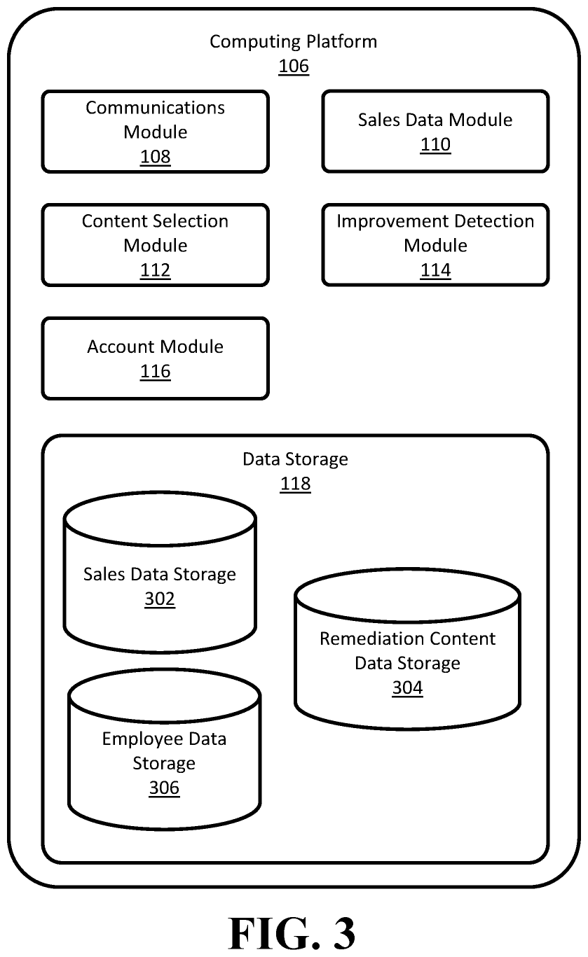

FIG. 3 depicts one embodiment of the computing platform 106. In one embodiment, the data storage 118 may include a sales data storage 302, a remediation content data storage 304, or an employee data storage 306. Each data storage 302, 304, 306 may include a database, file system, or some other type of data storage. In some embodiments, one or more of the data storages 302, 304, 306 may be located externally from the one or more computing devices that host the platform 106. The external data storages 302, 304, 306 may be in data communication with the platform 106 via the data network 104.

In one embodiment, the communications module 108 may coordinate data communications between the computing platform 106, the one or more POS systems 102(1)-(n), or a computing device 120. The communications module 108 may receive the sales data 206 from the one or more 102(1)-(n) and may store the sales data 206 in the data storage 118. For example, the communications module 108 may store the sales data 206 in the sales data storage 302. The sales data storage 302 may be configured to store the sales data 206 and organize the sales data 206 (e.g., by creating indices, generating metadata that makes the sales data 206 searchable, etc.). The sales data storage 302 may be configured to send a portion of the sales data 206 to one or more modules 108-116 of the computing platform 106.

The communications module 108 may be configured to receive or send other data. For example, and as will be discussed herein, the communications module 108 may transmit a notification to a computing device 120 of a selected employee 202 with a link or other way for the selected employee 202 to access remediation content. The communications module 108 may receive a notification from the computing device 120 of the selected employee 202 or from another computing device 120 indicating that the selected employee 202 has completed the remediation content. The communications module 108 may be configured to coordinate other data communication regarding the computing platform 106.

In one embodiment, the sales data module 110 may receive sales data 206 from the data storage 118. The sales data module 110 may use the sales data 206 to dynamically calculate a performance threshold (sometimes called a “statistical target performance threshold,” “employee performance threshold,” or simply a “threshold”) based on the sales data 206. The threshold may include a condition under which an employee 202 should be provided with remediation content.

In one embodiment, the threshold may be associated with an amount of total sales revenue. The threshold may be associated with the total sales of a particular item. The threshold may be associated with a length of time an employee 202 spends making a sale. In one embodiment, the threshold may be associated with a particular time or look back period. For instance, an employer may not want to look back only on a single days performance, but over a week or month to see trends more generalized trends across employees over time. The threshold may be associated with other types of data that may be derived from or based on sales data 206.

The following include examples of possible thresholds. A threshold may include sales revenue generated over a period of time (e.g., $10,000 in sales revenue over a month). A threshold may include an amount of a certain item, product type, bundles of products, or brand of items sold over a period of time (e.g., 30 shirts sold during a week). A threshold may include an average amount of time spent making sales (e.g., 1 hour per sale). A threshold may include an average transaction size per customer for a per employee transaction. A threshold may include a percentage of a certain product or service category. Categories of products or services may include products of a house brand; products from a specific vendor, manufacturer, or other entity; services provided by a certain entity; products of a certain nature (home goods, groceries, sporting goods, etc.); or other categories of products or services.

In one embodiment, the performance threshold can include a statistical performance threshold based on aggregated sales data from all employees. For instance, the threshold can be based on a mean, median, mode, percentile, or other statistical metric of the desired performance criteria across all employees. For example, the sales data module 108 may calculate a mean total sales for all employees based on the sales data 206. In some embodiments, for instance, where metrics across stores or regions are desired to be compared, the mean may include the mean sales per employee of a group of employees 202 over a specific time period. The group of employees 202 may include the employees 202 at a certain store (i.e. total sales of a store/the number of employees in that store), in a certain city, in a certain region (e.g., county, state, province, country, etc.), at a certain level (e.g., new employees, sales associates, management-level employees, etc.), a group of employees 202 selected by a person (e.g., by a manager or a company executive), a control group, or another group of employees 202. Group thresholds can then be calculated similarly to the employee thresholds noted above, and content can be provided to a group of employees as needed. The specific time period may include a most recent time period (e.g., the most recent day, week, two weeks, month, quarter, year, etc.), a specified time period (e.g., an interval between two dates, a sales season (e.g., a winter ski season, a summer, etc.)), or some other time period. In some embodiments, the threshold calculation can incorporate prior sales data for a specific time period in prior years to ascertain whether the entire field is down from prior years, and raising the threshold accordingly so that remediation can be provided to more of the target field collectively. The sales data module 108 dynamically calculating a threshold based on aggregated sales data from all employees or targets may include the sales data module 108 selecting a predetermined value below the mean as the threshold. The value may include a standard deviation, a percentage (e.g., 10% below the mean), a dollar amount, or some other value. In some embodiments, the threshold may be a relative percentile of employees, for instance ranking employees based on sales data and providing remediation content to the bottom quartile of employees. In the event multiple performance metrics are tracked, remediation or other content can be provided if any one metric is not hit but the target, the remediation content being geared toward that one metric, or an aggregated target threshold across all metrics can be calculated so that remediation can be provided only if a target does not meet the aggregated threshold incorporated the multiple metrics.

In some embodiments, the sales data module 110 dynamically calculating the threshold may include one or more other types of calculations. In one embodiment, the threshold may include a value below an average (e.g., a mean, median, or mode). For example, the sales data module 110 may calculate an average sales amount per employee 202, and the threshold may include a percentage below that average. In another embodiment, the sales data module 110 dynamically calculating the threshold may include the sales data module 108 receiving the threshold from user input. For example, a manager may set the threshold as $10,000 per month in sales revenue. In some embodiments, the data can be used to analyze behavior patterns for individuals operating at the highest levels, for instance to determine what behaviors facilitated them reaching and/or exceeding the threshold. Such analysis can help identify patterns beyond simply looking at key sales, POS, quality, market data thresholds, and ascertain “good” behaviors that facilitate high performance.

In some embodiments, the sales data module 110 dynamically calculating the threshold may include the sales data module 110 calculating thresholds on a rolling basis. Thresholds may include a rolling average, other real-time metrics, or other relatively continuous or frequent calculations. Using a dynamic statistical performance threshold based on aggregated sales data from all employees over time, as opposed to static predetermined thresholds, can allow a company to determine relative underperformance and/or over performance between employees while still accounting for seasonal trends, market factors, or other external circumstances, which may affect all employees as opposed to particular underperforming employees.

The sales data module 110 may determine, from the employee sales data 204 associated with an employee 202, whether the employee sales data 204 for the employee 202 is below the performance threshold at any given time. The sales data module 110 may retrieve employee sales data 204 for one or more employees 202 and calculate certain data points from the employee sales data 204 to compare against the threshold. For example, if the threshold is one standard deviation below the mean sales per employee 202 for the past month, the sales data module 110 may retrieve the employee sales data 204(1) for the employee 202(1) for the past month, calculate a sum of the employee's 202(1) sales, and determine whether the sum is one standard deviation below the mean.

In some embodiments, in response to the employee's 202(1) employee sales data 204(1) falling below the threshold, the sales data module 110 may generate data to mark the employee 202(1) as requiring corrective action. The generated data may include data to be stored in the employee data storage 306 and associated with the employee's 202(1) data.

In one embodiment, the corrective action may include an employee 202 being required to view, listen to, or otherwise participate in remediation content. The remediation content may include one or more videos, one or more audio tracks, one or more documents, one or more tests, one or more lectures, one or more training sessions, or other types of training content. Such training content can be either virtual or hands on. In some embodiments, the remediation content data storage 304 may store the remediation content or data whereby an employee 202 can access the remediation content. For example, the remediation content data storage 304 may store one or more video files, audio files, or text documents for an employee 202 to view, listen to, or read.

In some embodiments, the remediation content data storage 304 may include one or more software applications, web pages, or other software that an employee 202 can interact with in order to view videos, hear audio, read text, take a test, or otherwise interact with remediation content. The remediation content data storage 304 may include data indicating the time, place, or other information of an in-person lecture or remediation session. The remediation content may include a video or audio livestream of a lecture or a remediation event. In some embodiments, the remediation content data storage 304 may store links to one or more pieces of remediation content stored on a third-party server or other computing platform.

In one or more embodiments, the remediation content may include a positive incentive. The remediation content may include a punitive incentive.

In some embodiments, the remediation content stored in the remediation content data storage 304 may include metadata that may assist in classifying the remediation content. The metadata may include data indicating what type of deficiency the remediation content in intended to remediate (e.g., low sales, not selling enough of a certain item, spending too much time making a sale, etc.). The metadata may include other data.

In one embodiment, in response to the employee sales data 204 for the employee 202 being below the threshold, the content selection module 112 may select remediation content for the employee 202. The content selection module 112 may select specific items of remediation content based on the threshold. For example, if the threshold is based on sales revenue and the employee 202 failed to exceed the threshold because the employee's 202 sales were below the threshold, the content selection module 112 may select remediation content intended to increase the employee's 202 sales generally. In another example, if the threshold is based on time spent making sales and the employee 202 failed to exceed the threshold because the employee 202 spends too much time per sale, the content selection module 112 may select remediation content intended to increase the employee's 202 efficiency. The content selection module 112 may select the remediation content based on the metadata associated with the remediation content. In some embodiments, the performance system can be equipped to capture customer satisfaction data, such as by allowing customers to rate their experiences, and customer satisfaction data can be compare across a group of targets to facilitate remediation where needed.

In one embodiment, the content selection module 112 may send a notification to the employee 202. The notification may include a link to access the selected remediation content. The notification may include an email, a short message service (SMS) message, a message through a software application (e.g., an instant messaging application), a message on a messaging portion of the computing platform 106, or some other notification. The link may include a link to the selected remediation content in the remediation content data storage 304 or remediation content stored externally from the computing platform 106 (e.g., a link to a video on a third-party video hosting platform). The employee 202 may view the notification on or access the remediation content through the computing device 120 (which may include a personal device of the employee 202 or a work-provided device), a POS system 102 that the employee 202 can use, or some other computing device. In some embodiments, remediation prompts or other product information prompts can be presented to the employee 202 during the transaction itself to provide remediation during the transaction itself as opposed to after the fact.

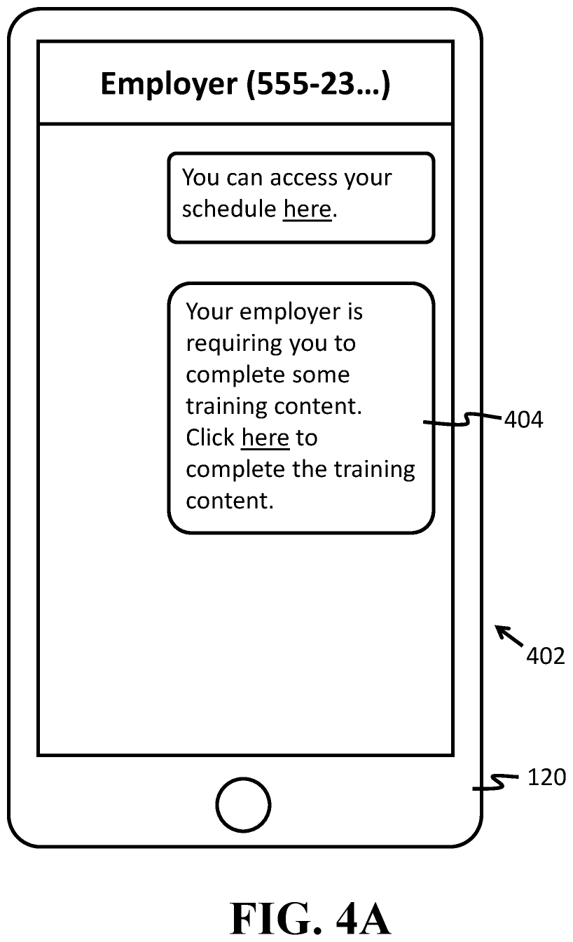

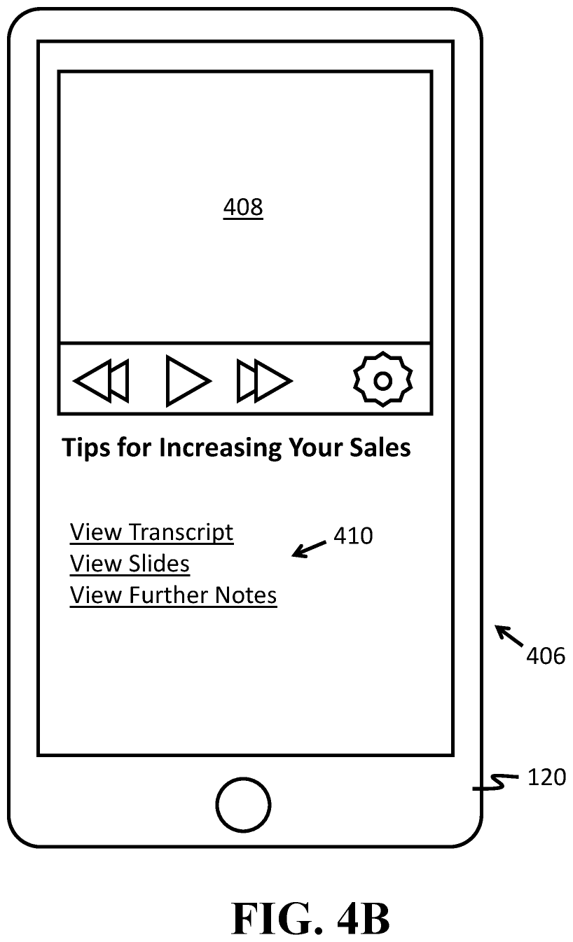

FIG. 4A depicts one embodiment of a computing device 120. As can be seen from FIG. 4A, the computing device 120 may include a personal mobile device of an employee 202. The computing device 120 may include a screen that can display a user interface (UI) 402. The UI 402 may include the UI of a messaging application. The UI 402 may display a notification 404. The notification 404 may include a message of the messaging application. The notification 404 may include text providing instructions to the employee 202 to complete remediation content. The notification 404 may include a link that the employee 202 can use to access the remediation content.

FIG. 4B depicts another embodiment of the computing device 120. As can be seen in FIG. 4B, the computing device 120 may display another UI 406. The UI 406 may include the UI of a video player. The computing device 120 may display the UI 406 in response to the employee 202 clicking on the link in the notification 404. The UI 406 may include a video 408, which may include controls for controlling the playback of the video 408. The video 408 may form part of the remediation content selected for the employee 202. The UI 406 may include further remediation content 410 such as links to text documents, other videos, or other types of remediation content, as well as certifications, certificates, badges, or micro-badges once remediation is complete.

In certain embodiments, the communications module 108 may send a notification to an employer of the employee 202 (e.g., the employee's 202 manager, team leader, etc.). The notification may provide information about the employee 202 and his or her failing to exceed the threshold. The notification may provide information about a history of the employee 202 failing to exceed thresholds. In some embodiments, in response to the employee 202 competing the selected remediation content, the communications module 108 may send a notification to the employer notifying the employer that the employee 202 has completed the selected remediation content.

In some embodiments, the content selection module 112 may be configured to automatically administer a positive incentive to the employee 202. The content selection module 112 may be configured to automatically administer a punitive incentive to the employee 202.

In one embodiment, the computing platform 106 may provision one or more employee accounts on the platform 106. An employee account may include account that stores information about an employee 202 and by which an employee 202 or the employee's 202 employer may view information regarding the employee 202. The employee account may store biographical information of the employee 202 (e.g., name, birthdate, government identification numbers, etc.), employment information (e.g., the employee's schedule, access to an employee manual, etc.), or other information. The employee 202 may login to the platform 106 to access to the employee's 202 account. In some embodiments, the computing platform 106 may store employee account data in the employee data storage 306 of the data storage 118 of the platform 106.

As discussed above, the sales data module 110 may generate data to mark the employee 202 as requiring corrective action in response to the employee 202 failing to exceed the threshold. The data used to mark the employee as requiring corrective action may include data stored as part of the employee's account data. The data may include information about the threshold the employee failed to exceed. Thus, the employee may view his or her employee account and see if he or she has failed to exceed any thresholds and must participate in remediation content. In response to the employee participating in the required remediation content, the account module 116 may generate data indicating the employee completed the remediation content. The sales data module in some embodiments can also include other employee information, such as employee salary, overall revenue to retail, brand productivity numbers, employee designation (e.g., influencer, power salesman, solid, not achieving, etc.).

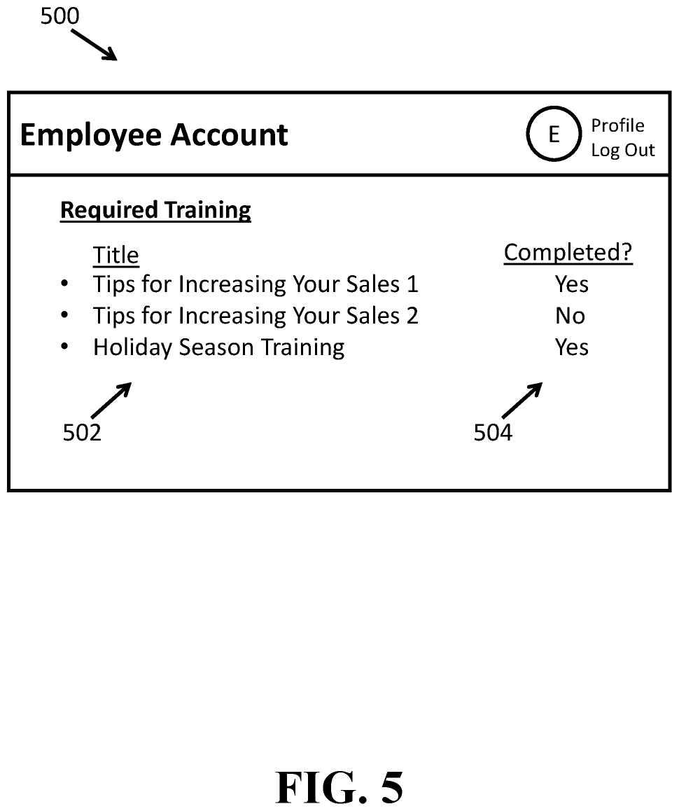

FIG. 5 depicts one embodiment of a UI 500. The UI 500 may include a UI of a software application where an employee 202 can view his or her employee account (e.g., a web browser). In one embodiment, the UI 500 may include a list 502 of remediation content that the employee 202 has been assigned by the content selection module 112. The UI 500 may include a UI element 504 indicating whether the employee 504 has completed the assigned remediation content. The UI element 504 may include text data (e.g., “Yes” or “No” as shown in FIG. 5), a checkbox, or some other UI element capable of indicating whether the employee 202 has completed the remediation content. The UI 500 may display the data based on employee account data stored in the employee data storage 306. In some embodiments, the UI 500 may include a progress bar associated with the list 502 (e.g., indicating the progress the employee 202 is making in completing an item of remediation content or the progress the employee 202 is making in completing all assigned items of remediation content. The UI 500 may include other data such as the date the content selection module 112 assigned the remediation content to the employee 202, the date the employee 202 completed an item of remediation content, or other data.

The account module 116 may allow an employer user of the platform 106, an administrative user of the platform 106, or some other leader to view one or more employee's 202 employee account data in order to determine whether an employee 202 has completed the required remediation content. The platform 106 may allow this in order to allow the employer, administrator, or other user to follow-up with the employee 202 or encourage the employee 202 to compete the remediation content.

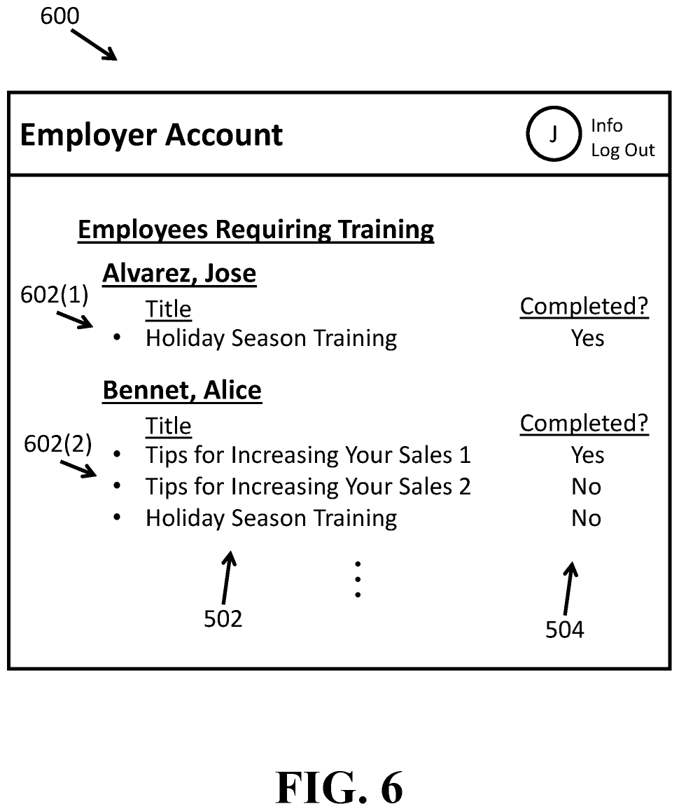

FIG. 6 depicts one embodiment of a UI 600. The UI 600 may include a UI of a software application where an employer can view a list of remediation content assigned to employees 202 and whether an employee 202 has completed his or her assigned remediation content. The UI 600 may include a list 602(1)-(o) of employees 202. Under each employee 202 of the list 602(1)-(o), the UI 600 may include a list 502 the remediation content assigned to that employee 202 and a UI element 504 indicating whether that employee 202 has completed the remediation content. The UI 600 may include one or more UI elements of the UI 500, discussed above (e.g., progress bars, completion dates, etc.). In some embodiments, the UI 600 can show reports of employees above and below a selected performance threshold.

In some embodiments, the sales data module 110 may track the employee's 202 employee sale data 204 in order to determine net change following the employee's 202 completion of the selected remediation content. The sales data module 110 may do this in order to determine whether the selected remediation content was effective at remediating the employee's 202 deficiency.

In one embodiment, the content selection module 112 may receive a notification indicating that the selected employee 202 has completed the remediation content that was assigned to the employee 202. The content selection module 112 receiving this notification may include the communications module 108 receiving a notification from the computing device 120 of the employee 202 where the computing device 120 may detect that the employee 202 completed the remediation content. The content selection module 112 receiving the notification may include the communications module 108 receiving a notification from a third-party computing device 120 (e.g., from a third-party's platform that hosts the remediation content). The content selection module 112 receiving this notification may include the content selection module 112 analyzing data in the employee data storage 306 and determining from that data that the employee 202 has completed the remediation content.

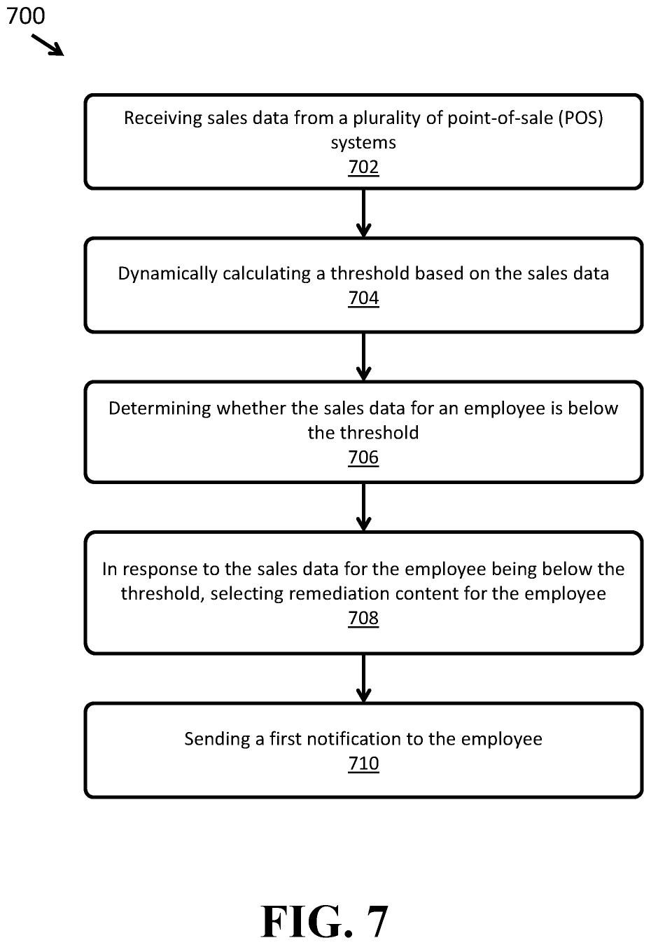

FIG. 7 depicts one embodiment of a method 700. The method 700 may include a computer-implemented method for dynamically providing content. The method 700 may include a computer-implemented method for dynamically providing other activities, trade, promotions, incentives, or other content. The method 700 may include receiving sales data 206 from a plurality of point-of-sale (POS) systems 102(1)-(n) (step 702). The sales data may include employee sales data 204(1)-(m) associated with a plurality of employees 202(1)-(m). The method 700 may include dynamically calculating a threshold based on the sales data 206 (step 704). The method 700 may include determining, from the employee sales data 204(1) associated with an employee 202(1) of the plurality of employees 202(1)-(m), whether the employee sales data 204(1) for the employee 202(1) is below the threshold (step 706). The method 700 may include, in response to the employee sales data 204(1) for the employee 202(1) being below the threshold, selecting remediation content for the employee 202(1) (step 708). The method 700 may include sending a notification 404 to the employee 202 (step 710). The notification 404 may include a link to access the remediation content.

In some embodiments, the method 700 may include one or more other actions or steps carried out by one or more elements of the system 100 that have been discussed previously. In some embodiments, one or more modules 108-116 of the platform 106 may carry out one or more steps of the method 700.

In one embodiment, the system 100 may also detect improved data. The improved data may include improvements in the sales data 204 associated with a certain target, such as an employee, sales region, or retail location. The improved data may include improvements in the aggregated sales data 206. The improved sales data may assist in identifying whether a certain piece of remediation content dynamically selected by the system 100 was effective in improving the performance of the target.

In some embodiments, the employee sales data 204 or the sales data 206 may pertain to a specific time period. For example, an employee's sales data 204(1) may pertain to a specific day, week, month, quarter, year, or portion thereof. The same may be true for the sales data 206. In some embodiments, a first set of employee sales data 204 or sales data 206 may pertain to a first time period, and a second set of employee sales data 204 or sales data 206 may pertain to a second time period. The first and second time periods may at least partially overlap or may be completely distinct. The first time period may occur at least partially before the second time period.

In one or more embodiments, the sales data 204(1)-(m) received by the communications module 108 or the sales data 206 aggregated by the sales data module 108 may pertain to a first time period. The communications module 108 may receive second target sales data from the one or more POS systems 102(1)-(n). The second target sales data may include target sales data pertaining to a second time period, and the second time period may include a time period that occurs after the selected target has completed the remediation content. The improvement detection module 114 may compare the first target sales data associated with the selected target 204(1) and determine an amount of improvement between the two sets of target sales data associated with the selected target. This determination may indicate that the remediation content was successful in helping the selected target improve.

In some embodiments, the improvement detection module 114 may be configured to compare the employee sales data 204(1) from the second set of sales data 206 with at least a portion of the first set of sales data 206 to determine if the second set of sales data 206 indicates improvement and, if so, the amount of improvement. In some embodiments, the improvement detection module 114 may compare the employee sales data 204(1) from the second set of sales data 206 with employee sales data 204(1) from the first set of sales data 206. In certain embodiments, the improvement detection module 114 may compare the employee sales data 204(1) from the second set of sales data 206 with the threshold that was calculated using the first set of sales data 206. In certain embodiments, the improvement detection module 114 may compare the employee sales data 204(1) from the second set of sales data 206 with an updated threshold, and the sales data module 110 may have generated the updated threshold based on the second set of sales data 206 or a combination of the first set of sales data 206 and the second set of sales data 206.

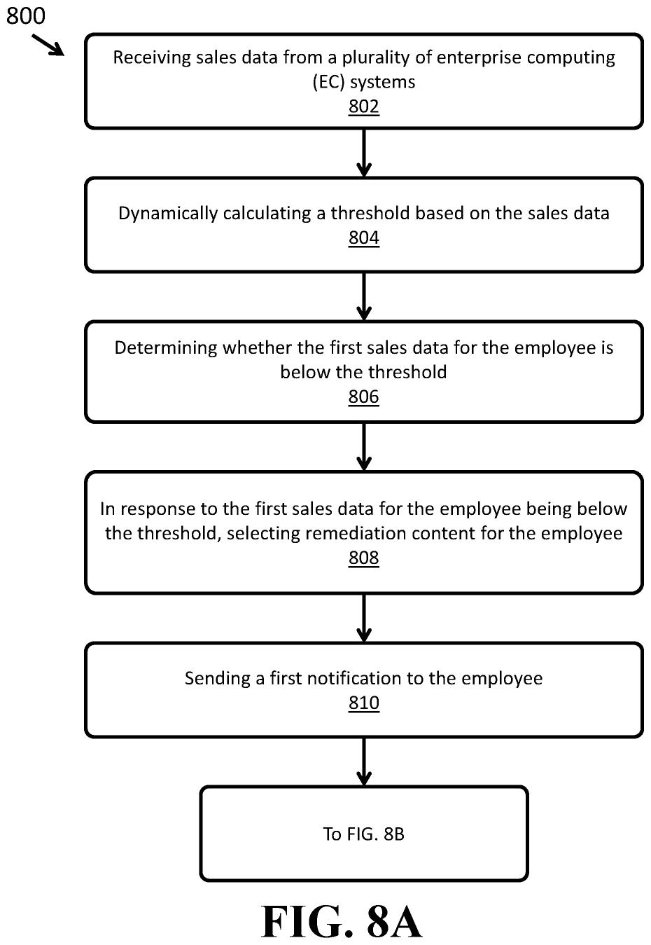

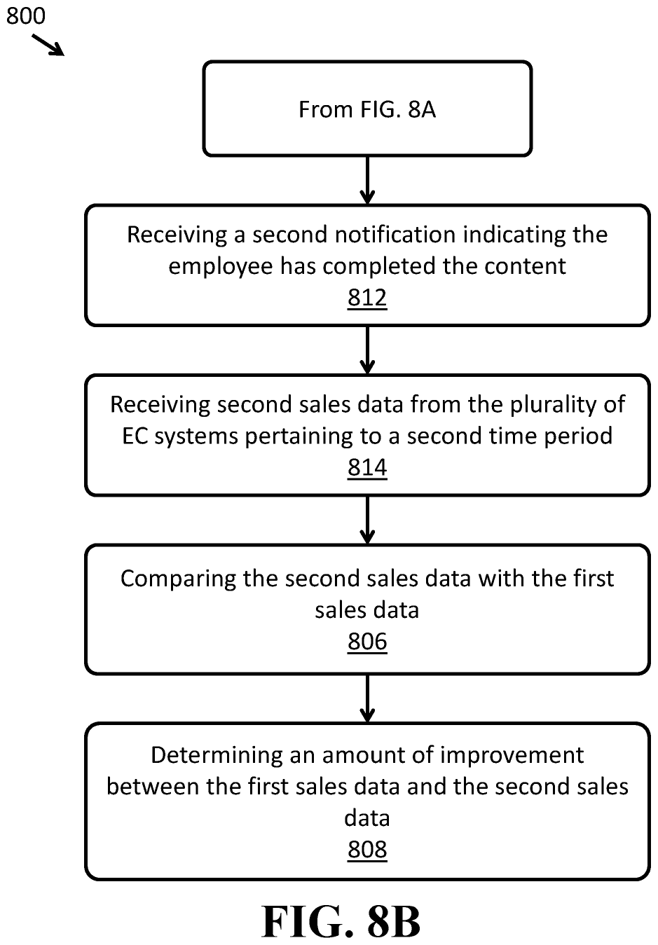

FIGS. 8A-8B depict one embodiment of a method 800. The method 800 may include a computer-implemented method for detecting improved data. The method 800 may include receiving first sales data 206 from a plurality of point-of-sale (POS) systems 102(1)-(n) (step 802). The first sales data 206 may include employee sales data 204(1)-(m) associated with a plurality of employees 202(1)-(m). The first sales data 206 may pertain to a first time period. The method 800 may include dynamically calculating a statistical employee performance threshold based on the first sales data 206 (step 804). The method 800 may include determining, from the first sales data associated with a selected employee 204(1) of the plurality of employees 202(1)-(m), whether the first sales data associated with the selected employee 204(1) is below the employee performance threshold (step 806). The method 800 may include, in response to the first sales data associated with the selected employee 204(1) being below the employee performance threshold, selecting remediation content for the selected employee 202(1) (step 808). The method 800 may include sending a first notification 404 to the selected employee 202(1) (step 810). The first notification 404 may include a link to access the remediation content. The method 800 may include receiving, at the communication module 108, a second notification indicating that the selected employee 202(1) has completed the remediation content (step 812). The method 800 may include receiving second sales data 206 from the plurality of POS systems 102(1)-(n) (step 814). The second sales data 206 may pertain to a second time period, and the second time period may have occurred after receiving the second notification. The method 800 may include comparing the second sales data associated with the selected employee 204(1) with the first sales data associated with the selected employee 204(1) (step 816). The method 800 may include determining an amount of improvement between the second sales data associated with the selected employee 204(1) and the first sales data associated with the selected employee 204(1) (step 818).

Another advantage of the present system 100 over the prior art is that the system 100 can detect a variety of improvements in sales data. Prior art systems generally cannot detect changes in sales data apart from whether a certain metric increased or decreased. The present system 100, on the other hand, can detect various metric and sales data changes, which may aid in determining whether a certain remediation content is effective.

In some embodiments, the system 100 may include an artificial intelligence or machine learning module to measure all data inputs to dynamically and iteratively generate an individual employee profile based on sales data received that can then be matched to workforce solutions through a series of training, education and remediation steps. The goal is ultimately to improve upon employee skills and aspirations to match employer goals and outcomes and optimize the success of both participants. The artificial intelligence or machine learning module can be programmed to (1) automate machine learning data feature extraction from the system, (2) create a suggested training profile based on data received by the artificial intelligence or machine learning module and prior employee improvement outcome data for different training methods (3) provide training using the suggested training profile and producing a validation set of data to compare against prior training improvement outcome data, and (4) iteratively repeating steps (1), (2), and (3) to change, improve, enhance, or adjust the suggested training profiles given different data inputs to optimize improvement outcomes. The AI module can then monitor outcomes for differing training approaches, and based on such outcomes either alter or maintain training programs to address identified sales issues going forward.

In some embodiments, in addition to monitoring employee or representative training and sales data, the system 100 can also monitor other factors that can drive improved margins for a product in order to optimize a combination of training efforts and business marketing efforts. For instance, the system 100 can track certain items such as high product margins for certain products, training efforts for such products, discount or promotional pricing for such products, bundled product offers with such products, employee sales incentives for such products, demographic information, and other various metrics and obtain improvement data after implementation of various combinations of the above noted metrics in an effort to optimize such metrics. In some embodiments, the system 100 can include a machine learning module 100 to help predict based on prior sales data successful combinations of metrics and drive optimal margins for different products in the future. While often times product margins are a significant business driver or KPI to be measured, the system 100 disclosed herein could also be used to measure different performance input drivers and resulting output metrics and optimize various other business KPIs or metrics, including but not limited to employee retention metrics, customer ratings or reviews, gross sales outputs, company stock prices, average basket size, gross margin, sell-thru rates (per product), customer acquisition, upselling, online order sizes, sale promotions, dollar value per shift, aging inventory, sample give-aways, repeat purchases/frequency, loyalty sign-ups, accuracy/error rates, quality standards, compliance standards, employee reliability, efficacy of onboarding, etc.

Similarly, with an aging inventory tracking system, the system 100 could track what inventory is aging, product training efforts around such aging inventory, employee inventive programs, and consumer discounts to help optimize sales strategies for such aging products in the future.

In embodiments using machine learning or artificial intelligence modules, as more ad more test cases are conducted for a particular program or module, the artificial module will have more and more empirical data to mine to better drive predictive outcomes in the future.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable media.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present disclosure of new and useful systems and methods dynamically providing content, it is not intended that such references be construed as limitations upon the scope of this disclosure.

What is claimed is:

1. A system, comprising:
a plurality of enterprise computing systems (EC) systems, wherein the plurality of EC systems is configured to track target sales data for each of one or more targets; and
a computing platform, including
a communication module configured to receive first target sales data for each target from the plurality of EC systems,
a sales data module configured to
periodically calculate a statistical target performance threshold based on the aggregated first target sales data of all targets, and
determine, from the first target sales data associated with a selected target, whether the first target sales data associated with the selected target is below the target performance threshold,
a content selection module configured to
in response to the first target sales data associated with the selected target being below the target performance threshold, select remediation content for the selected target, and
send a first notification to the selected target, wherein the first notification includes a link to access the remediation content.

2. The system of claim 1, wherein the content selection module is further configured to automatically administer a positive incentive to the selected target.

3. The system of claim 1, wherein the content selection module is further configured to automatically administer a punitive incentive to the selected target.

4. The system of claim 1, wherein a EC system of the plurality of EC systems comprises at least one of:
a cash register;
a barcode scanner; or
a computing device.

5. The system of claim 1, wherein a EC system of the plurality of EC systems comprises at least one of:
an inventory management system;
a customer relationship management system; or
a warehousing system.

6. The system of claim 1, wherein a target of the one or more targets comprises at least one of:
an employee;
a plurality of employees located in a predetermined location; or
a store.

7. The system of claim 6, wherein the predetermined location comprises at least one of a retail location or a sales region.

8. The system of claim 1, wherein:
the first target sales data pertains to a first time period;
the communication module is further configured to
receive a second notification indicating that the selected target has completed the remediation content, and
receive second target sales data from the plurality of EC systems, wherein
the second target sales data pertains to a second time period, and
the second time period occurs after the content selection module receives the second notification;
the computing platform further includes an improvement detection module configured to
compare the second target sales data associated with the selected target with the first target sales data associated with the selected target, and
determine an amount of improvement between the second target sales data associated with the selected target and the first target sales data associated with the selected target.

9. A computer-implemented method, comprising:
receiving first employee sales data from a plurality of enterprise computing (EC) systems, wherein the first employee sales data includes employee sales data associated with a plurality of employees;
dynamically calculating a statistical employee performance threshold based on the aggregated first employee sales data from all of the plurality of employees;
determining, from the first employee sales data associated with a selected employee of the plurality of employees, whether the first employee sales data associated with the selected employee is below the employee performance threshold;
in response to the first employee sales data associated with the selected employee being below the employee performance threshold, selecting remediation content for the selected employee; and
sending a first notification to the selected employee, wherein the first notification includes a link to access the remediation content.

10. The method of claim 9, wherein dynamically calculating the employee performance threshold comprises:
calculating a mean sales rate per target based on the aggregated first employee sales data for a predetermined look-back period;
selecting a predetermined amount or percentage below the mean sales rate per target as the employee performance threshold; and
repeating the calculating and selecting steps periodically to determine a new employee performance threshold.

11. The method of claim 9, wherein dynamically calculating the threshold comprises calculating one or more rolling mean sales rate per target based on the aggregated first employee sales data on at least a daily basis.

12. The method of claim 9, wherein dynamically calculating the employee performance threshold comprises calculating a mean sales rate per target based on the first employee sales data associated with a subset of the plurality of employees.

13. The method of claim 9, wherein dynamically calculating the employee performance threshold comprises calculating a mean transaction size per customer for a per employee transaction.

14. The method of claim 9, wherein dynamically calculating the employee performance threshold is based on a subset of the first employee sales data associated with a predetermined product category.

15. The method of claim 9, further comprising automatically administering a positive incentive to the selected employee.

16. The method of claim 9, further comprising automatically administering a punitive incentive to the selected employee.

17. The method of claim 9:
wherein the first employee sales data pertains to a first time period; and
further comprising
receiving a second notification indicating that the selected employee has completed the remediation content,
receiving second employee sales data from the plurality of EC systems, wherein
the second employee sales data pertains to a second time period, and
the second time period occurs after receiving the second notification,
comparing the second employee sales data associated with the selected employee with the first employee sales data associated with the selected employee, and
determining an amount of improvement between the second employee sales data associated with the selected employee and the first employee sales data associated with the selected employee.

18. A system, comprising:
a computer processor; and
a computer-readable storage medium storing computer-executable instructions thereon, wherein the computer processor, in response to executing the computer-executable instructions, is configured to
receive first sales data from a plurality of enterprise computing (EC) systems, wherein
the first sales data includes employee sales data associated with a plurality of employees, and
the first sales data pertains to a first time period;
dynamically calculate a statistical employee performance threshold based on the first sales data;
determine, from the first sales data associated with a selected employee of the plurality of employees, whether the first sales data associated with the selected employee is below the employee performance threshold;
in response to the first sales data associated with the selected employee being below the employee performance threshold, select remediation content for the selected employee;
send a first notification to the selected employee, wherein the first notification includes a link to access the remediation content;
receive a second notification indicating that the selected employee has completed the remediation content;
receive second sales data from the plurality of EC systems, wherein
the second sales data pertains to a second time period, and
the second time period occurs after receiving the second notification;
compare the second sales data associated with the selected employee with the first sales data associated with the selected employee; and
determine an amount of improvement between the second sales data associated with the selected employee and the first sales data associated with the selected employee.
